(19) United States
(12) Patent Application Publication
(10) Pub. No.: US 2011/0074731 A1
(43) Pub. Date: Mar. 31, 2011

(54) INPUT DEVICE, INPUT PROCESSING PROGRAM, AND INPUT CONTROL METHOD

(75) Inventors: Kinya INOUE, Kawasaki (JP); Hiroshi Fujita, Kawasaki (JP); Susumu Nikawa, Kawasaki (JP)

(73) Assignee: FUJITSU LIMITED, Kawasaki-shi (JP)

(21) Appl. No.: 12/893,475

(22) Filed: Sep. 29, 2010

(30) Foreign Application Priority Data
Sep. 30, 2009 (JP) 2009-228845

(51) Int. Cl. G06F 3/045

(52) U.S. Cl. 345/174

(57) ABSTRACT

An input device and input control method including: a capacitance measurement unit to measure capacitances of a plurality of electrodes arranged on a touch panel; a deflection determination unit to determine a presence or absence of a deflection occurring in the touch panel based on a distribution of results of the capacitances of the electrodes; and a coordinate output unit to output coordinate data of an operation input on the touch panel based on the distribution of results.

### CROSS-REFERENCE TO RELATED APPLICATION(S)

This application is based upon and claims the benefit of priority of the prior Japanese Patent Application No. 2009-228845, filed on Sep. 30, 2009, the entire contents of which are incorporated herein by reference.

### BACKGROUND

1. Field

The present invention relates to an input device, an input processing program, and an input control method.

2. Description of the Related Art

Touch panels have been recognized as operation input devices (e.g., Japanese Unexamined Patent Application Publication No. 2007-109082). The touch panel is an input device configured to detect when a finger or the like comes into contact with an operation screen and to output data of the coordinates. The Touch panel may be placed over a display device including, for example, a liquid crystal display (LCD).

A capacitance detection method has been used as one of the detection methods that are appropriate for the touch panel to detect the contact. A touch panel using the capacitance detection method includes a plurality of electrodes arranged on the operation screen of the touch panel so as to detect a change in a capacitance, the change being caused by a finger or the like coming into contact with the operation screen.

According to the touch panel using the capacitance detection method, the change in the capacitance is detected, where the change is caused by the finger or the like coming into contact with the touch panel. However, the change in the capacitance is also caused by a change in the configuration of the electrode part of the touch panel. As a result, when the amount of a change in the capacitance exceeds a threshold value, with such a change being caused by the change in the configuration of the electrode part of the touch panel, an erroneous input occurs so that it is determined that an operation input occurs even though no operation input is accepted in actuality. The change in the configuration of the electrode part of the touch panel occurs when a user presses the operation screen with a higher strength than is necessary or when pressure is exerted on the frame of the touch panel.

The occurrence of the erroneous input for the touch panel will be described with reference to the drawings. Each of FIGS. 10A and 10B illustrates how electrodes are arranged on a touch panel. As illustrated in each of FIGS. 10A and 10B, the touch panel P2 is placed over a liquid crystal display P1. The touch panel P2 includes ten electrodes X1 to X10 that are arranged in the X-coordinate axis direction and fourteen electrodes Y1 to Y14 that are arranged in the Y-coordinate axis direction.

When the finger of a user comes into contact with the touch panel P2, the coordinates of the finger contact position may be determined based on a change in the distribution of capacitances of each of the electrodes X1 to X10 and the electrodes Y1 to Y14. Further, the movement of the finger contact position may be detected by measuring the distribution of the capacitances of each of the electrodes X1 to X10 and the electrodes Y1 to Y14 repeatedly. According to the example illustrated in each of FIGS. 10A and 10B, the finger moves in the downward direction while reducing speed and the locus of the finger movement is displayed on the liquid crystal display P1. FIG. 10B schematically illustrates the locus of the finger movement, as the sign “◯” illustrated at the finger contact position detected in the example illustrated in FIG. 10A.

FIG. 11 is a section view of a touch panel input device, and each of FIGS. 12A and 12B is a circuit diagram of the touch panel electrodes. The touch panel includes a touch panel electrode arranged in the X-coordinate axis direction (X), a touch panel electrode arranged in the Y-coordinate axis direction (Y), and a cover panel that are placed over an LCD in that order, which means that space is provided between the touch panel and the LCD. Here, the LCD is grounded so that GND potential is obtained.

An X-electrode parasitic capacitance C1 illustrated in FIG. 11 is a capacitance occurring between the LCD functioning as a ground and the electrodes X1 to X10 that are arranged on the X-axis side. Likewise, a Y-electrode parasitic capacitance C2 is a capacitance occurring between the LCD and the electrodes Y1 to Y14 that are arranged on the Y-axis side. Further, an inter-XY electrode capacitance C3 illustrated in FIG. 11 is a capacitance occurring between the electrodes X1 to X10 that are arranged on the X-axis side and the electrodes Y1 to Y14 that are arranged on the Y-axis side. Still further, a finger capacitance Cf is a capacitance occurring between the electrodes X1 to X10 that are arranged on the X-axis side and a finger.

As illustrated in the circuit diagrams of FIGS. 12A and 12B, the touch panel is configured such that each of the electrodes Y1 to Y14 that are arranged on the Y-axis side is used as a ground for measuring the capacitances of the electrodes X1 to X10 that are arranged on the X-axis side. Further, when measuring the capacitances of the electrodes X1 to X10 that are arranged on the X-axis side, the touch panel measures the combined capacitance of the X-electrode parasitic capacitance C1, the inter-XY electrode capacitance C3, and the finger capacitance Cf for each of the electrodes X1 to X10. Further, when measuring the capacitances of the electrodes Y1 to Y14 that are arranged on the Y-axis side, the touch panel is configured such that the electrodes X1 to X10 that are arranged on the X-axis side are grounded and the combined capacitance of the Y-electrode parasitic capacitance C2, the inter-XY electrode capacitance C3, and the finger capacitance Cf is measured for each of the electrodes Y1 to Y14. Then, the touch panel performs the analog-to-digital (A/D) conversion for the value of each of the measured capacitances and determines the coordinates of the finger contact with the touch panel.

### SUMMARY

It is an aspect of the embodiments discussed herein to provide an input device including: measuring capacitances from a plurality of electrodes arranged on a touch panel; determining presence or absence of a deflection occurring in the touch panel based on distribution of results of the measurement of the capacitances of the electrodes; outputting data of coordinates of an operation input for the touch panel based on the capacitance measurement-result distribution; and stopping the outputting the coordinate data when the determining determines that the deflection is present.

The object and advantages of the invention will be realized and achieved by those features, elements, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating an exemplary input device according to a first embodiment;

FIG. 2 illustrates an exemplary configuration of a terminal device according to a second embodiment;

FIG. 3 illustrates exemplary electrodes of a touch panel;

FIG. 4 is a block diagram illustrating an exemplary touch input-functional unit according to the second embodiment;

FIG. 5 illustrates exemplary capacitances that are measured through a capacitance detection unit;

FIG. 6A illustrates exemplary processing performed to calculate the barycentric coordinates of capacitances;

FIG. 6B illustrates exemplary processing performed to calculate the barycentric coordinates of different capacitances;

FIG. 7A illustrates an exemplary deflection determination;

FIG. 7B also illustrates an exemplary deflection determination;

FIG. 8 is a flowchart illustrating exemplary flow of processing procedures that are performed through a terminal device according to the second embodiment;

FIG. 9 illustrates an exemplary computer executing a control program;

FIG. 10A illustrates an exemplary arrangement of electrodes of a touch panel in a related art;

FIG. 10B also illustrates an exemplary arrangement of the electrodes of the touch panel in a related art;

FIG. 11 is a section view of exemplary touch panel electrodes in a related art;

FIG. 12A is an exemplary circuit diagram of the touch panel electrodes in a related art;

FIG. 12B is another exemplary circuit diagram of the touch panel electrodes in a related art;

FIG. 13 illustrates an exemplary result of the measurement of capacitances occurring in the X-axis direction in a related art;

FIG. 14 illustrates an exemplary deflection occurring in the touch panel in a related art;

FIG. 15A illustrates an exemplary deflection occurring in the frame of the touch panel in a related art;

FIG. 15B also illustrates an exemplary deflection occurring in the frame of the touch panel in a related art;

FIG. 15C also illustrates an exemplary deflection occurring in the frame of the touch panel in a related art;

FIG. 16A illustrates an exemplary deflection detection in a related art;

FIG. 16B also illustrates an exemplary deflection detection in a related art;

FIG. 17A illustrates an exemplary data loss caused by a deflection occurring during the operation in a related art;

FIG. 17B also illustrates an exemplary data loss caused by the deflection occurring during the operation in a related art; and

FIG. 17C also illustrates an exemplary data loss caused by the deflection occurring during the operation in a related art.

### DESCRIPTION OF THE EMBODIMENTS

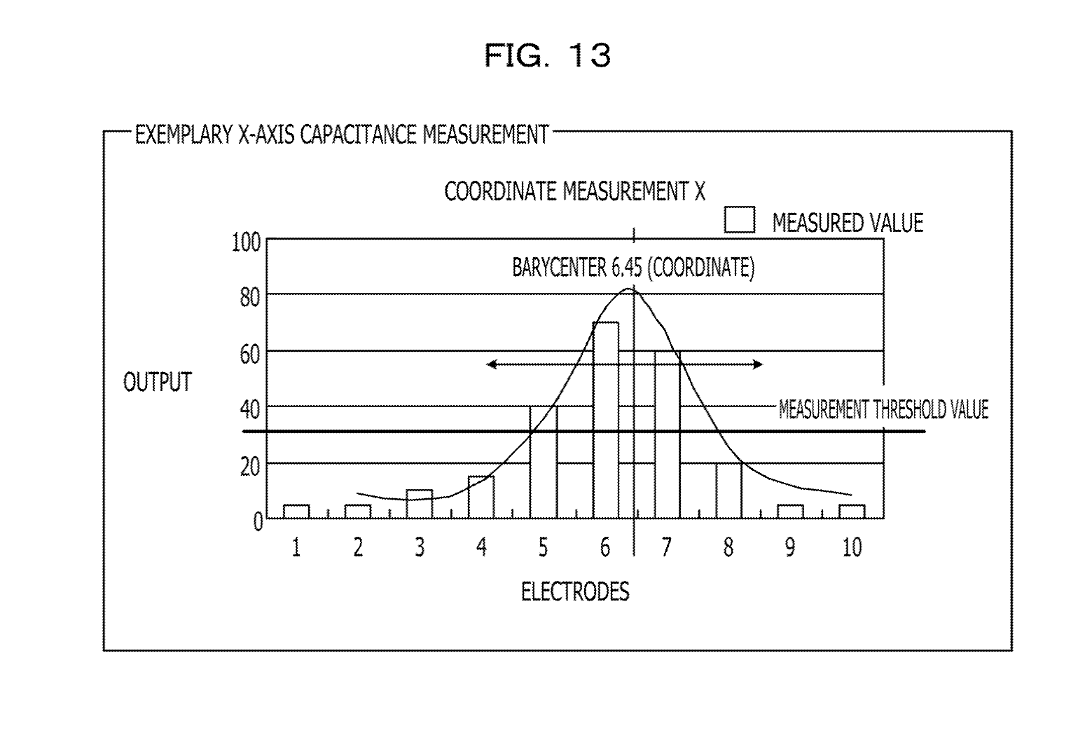

FIG. 13 illustrates a result of the measurement of the capacitances occurring in the X-axis direction caused by the finger or the like coming into contact with the touch panel. The touch panel may calculate the distribution of the measured capacitances of the electrodes X1 to X10, as illustrated in FIG. 13. The touch panel compares the maximum value of the capacitances with a given measurement threshold value. When the maximum value is larger than the measurement threshold value, the touch panel determines that the finger of the user has come into contact with the touch panel. In that case, the touch panel may calculate the barycenter of the distribution of the measured capacitances of the electrodes X1 to X10, and determine the calculated barycenter to be the X coordinate of the contact position. Likewise, the touch panel may calculate the Y coordinate of the contact position based on the distribution of the measured capacitances of the electrodes Y1 to Y14.

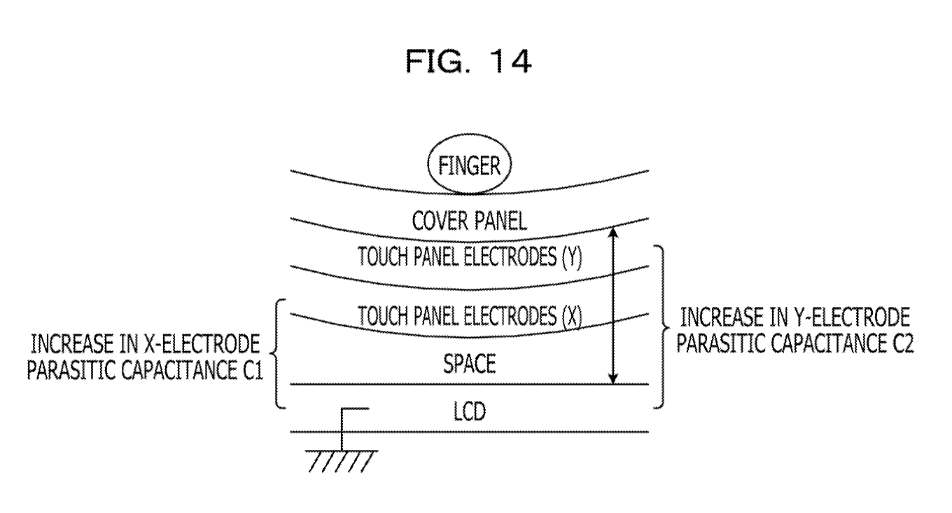

FIG. 14 illustrates the deflection occurring in the touch panel. When pressure is exerted on an operation screen and/or frame of the touch panel, a deflection occurs in the touch panel and the distance between the electrodes and the LCD is reduced. When the distance is reduced in that manner, the value of each of the X-electrode parasitic capacitance C1 and the Y-electrode parasitic capacitance C2 is increased.

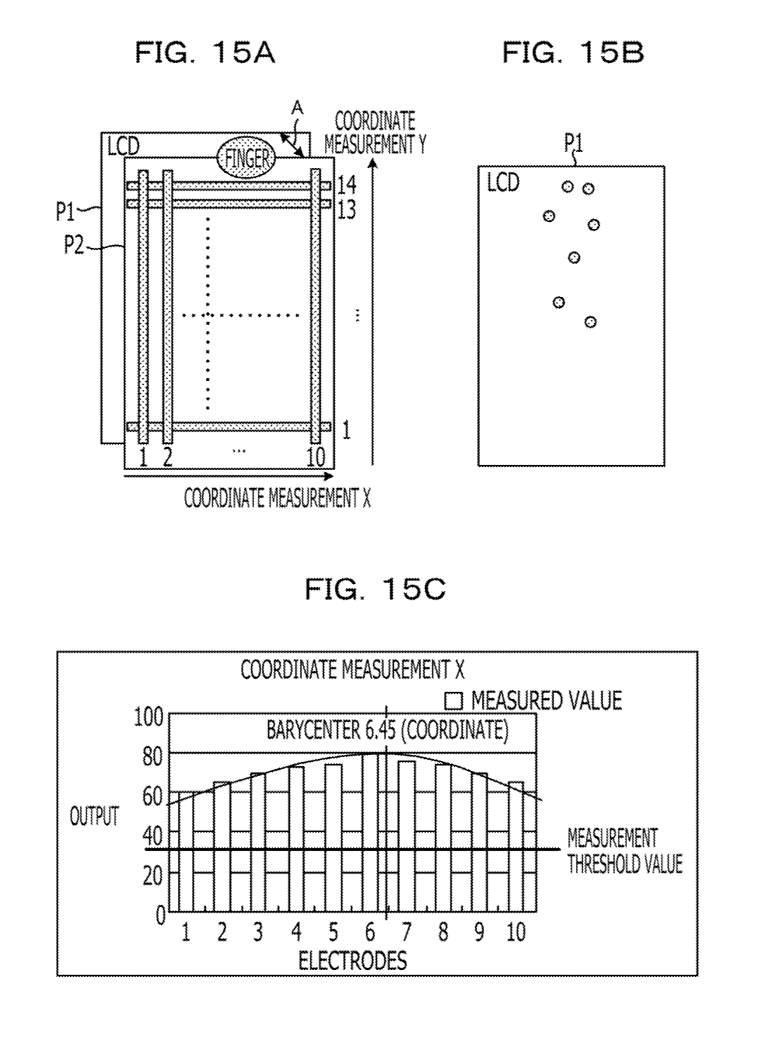

Each of FIGS. 15A, 15B, and 15C illustrates an erroneous input occurring due to a deflection occurring in the frame of the touch panel. When the frame of the touch panel P2 is pressed hard, a distance A between the liquid crystal display P1 and the touch panel P2 is reduced and a deflection occurs in nearby electrodes so that the values of the capacitances are increased as illustrated in each of FIGS. 15A to 15C. If the value of the distribution of the capacitances of the electrodes X1 to X10 that are arranged on the X-coordinate axis side exceeds the measurement threshold value as a result of the press, a false determination is made that the finger has come into contact with the touch panel P2 and data of the barycenter of the capacitance distribution is output as the contact position data even though the finger has not come into contact with the touch panel P2. FIG. 15B illustrates the sign “◯” as the finger contact position which is erroneously detected in the example illustrated in each of FIGS. 15A and 15C.

When increasing a threshold value provided to determine the presence or absence of contact for evading an erroneous input caused by a deflection occurring in a touch panel, the sensitivity of the touch panel is decreased. The apparatus according to the following embodiments may detect the presence or absence of the deflection occurring in the touch panel based on the distribution of capacitances, and may cancel the contact position calculation when the deflection occurring in the touch panel is present.

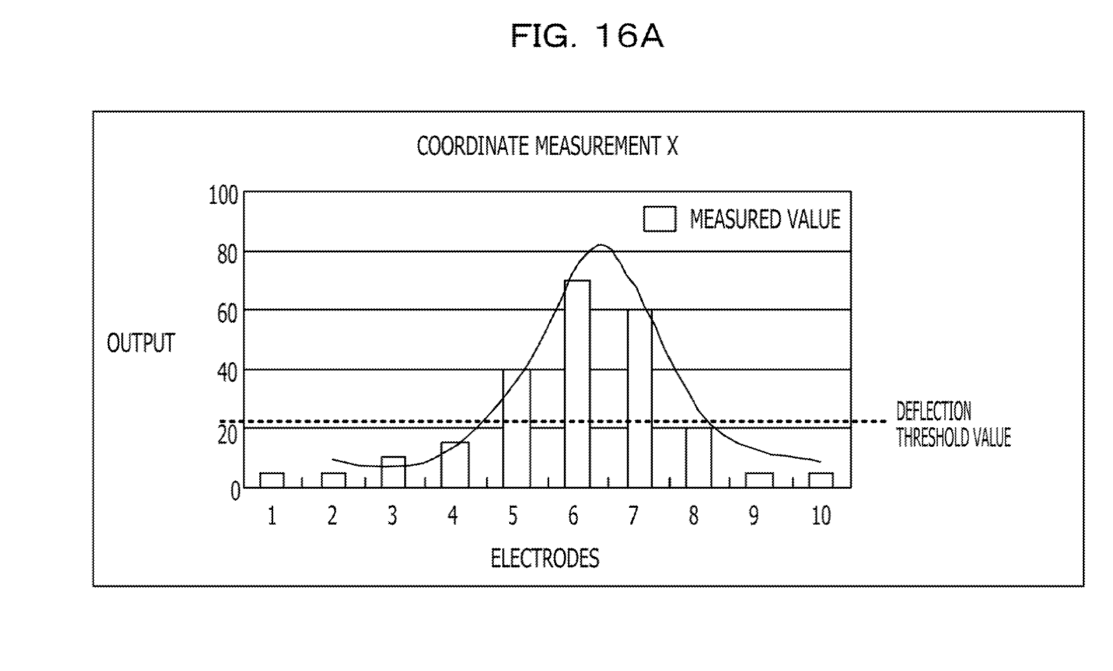

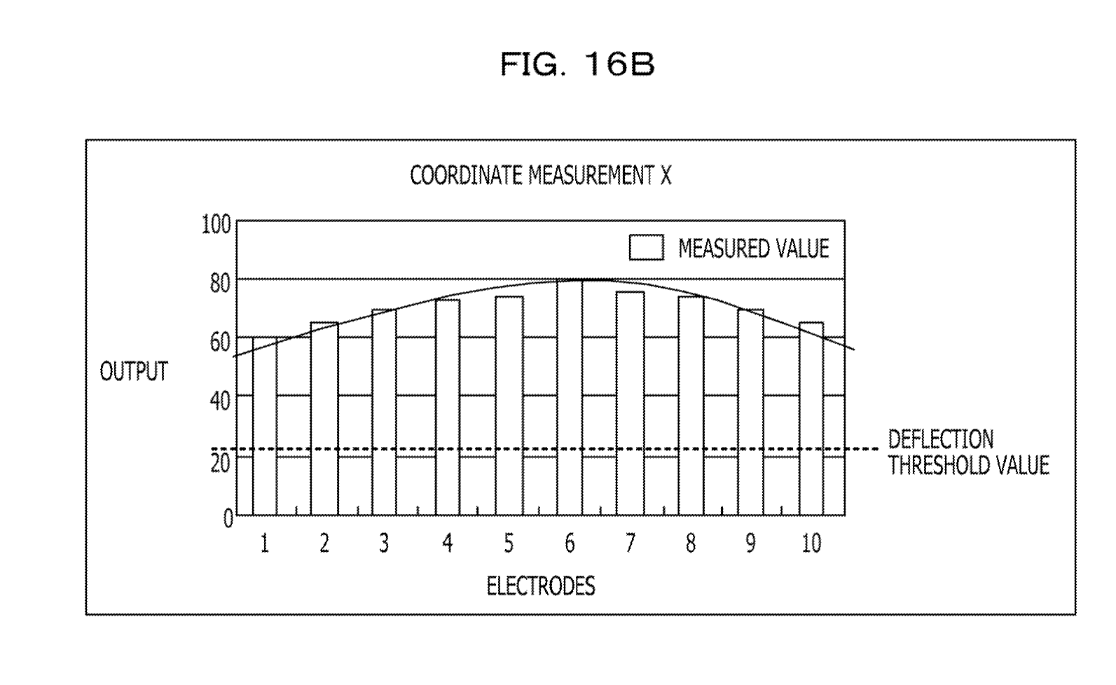

Each of FIGS. 16A and 16B illustrates the deflection detection. The touch panel has a deflection threshold value provided to perform the deflection detection aside from a measurement threshold value provided to detect contact. The touch panel calculates the number of electrodes that output a capacitance, where the value of the capacitance exceeds the deflection threshold value. When the value of the calculation result is substantially equivalent to and/or larger than the deflection threshold value, it is determined that a deflection occurs in the touch panel and the calculation of the contact position is cancelled.

The finger contact with the touch panel causes a large capacitance in an electrode provided at a position near the finger and a small capacitance in an electrode provided at a position far from the finger so that a capacitance distribution with a sharp peak is obtained. When a deflection occurs in the touch panel, the capacitance of each of the touch panel electrodes is increased so that a capacitance distribution with a gentle peak is obtained.

For example, the assumption is made that the touch panel determines that a deflection occurs when the values of capacitance outputs produced by at least five electrodes are larger than the deflection threshold value. According to an example shown in FIG. 16A, the number of the capacitance outputs values are larger than the deflection threshold value is three. Therefore, the touch panel determines that no deflection occurs, and determines the contact position. On the other hand, according to an example shown in FIG. 16B, the number of capacitance outputs having values larger than the deflection threshold value is ten so that the touch panel determines that a deflection occurs and cancels the contact position determination.

Thus, according to the method of setting the deflection threshold value and detecting the deflection occurring in the touch panel, the contact position calculation is cancelled when a predetermined number of values of capacitances are larger than the deflection threshold value. Further, when a user firmly presses the operation screen of the touch panel, a deflection occurs in the electrodes of the touch panel at and around the operation position. Consequently, the distribution of capacitances with a gentle peak may be measured. If the measurement of the contact position is cancelled under the above-described circumstances, data may be lost when the user firmly presses the touch panel during usage and operation of the touch panel.

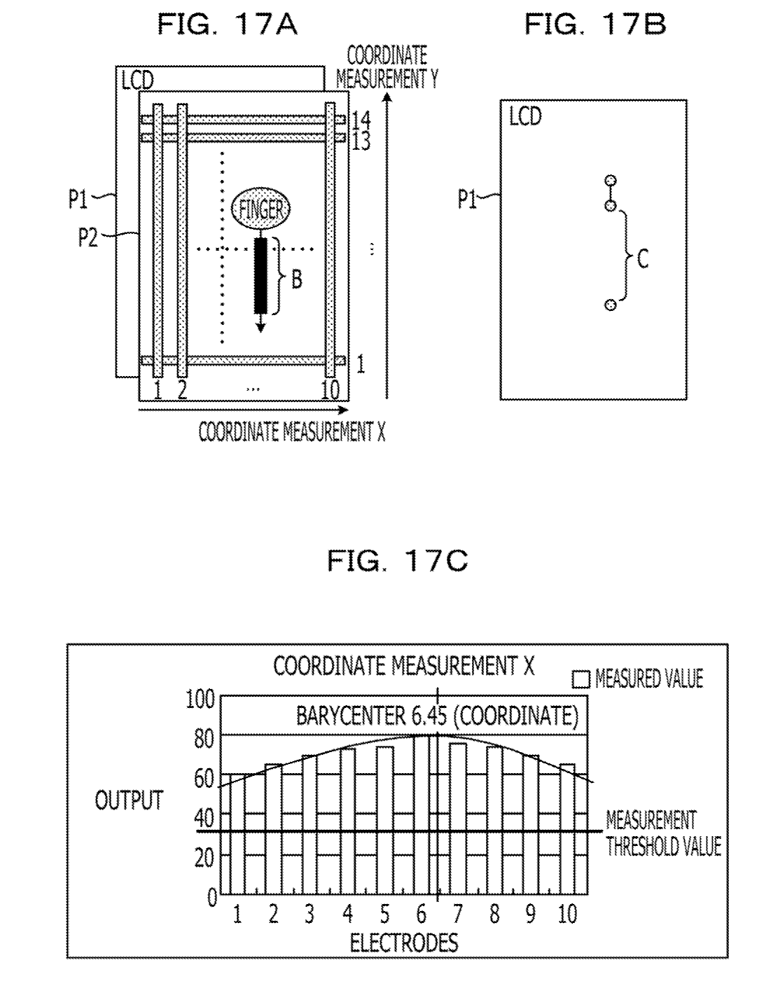

Each of FIGS. 17A, 17B, and 17C illustrates the data loss caused by a deflection occurring during the operation. When the user firmly presses the operation screen of the touch panel during the operation, a capacitance distribution with a gentle peak is obtained, as illustrated in FIGS. 17A, 17B, and 17C. According to the examples that are illustrated in FIGS. 17A, 17B, and 17C, the deflection occurs in a range B where the user performs the operation, the range B being defined on the touch panel. As a result, it is difficult for a liquid crystal display P1 to use data transmitted from the user in the display range C corresponding to the operation range B. Thus, when an input is cancelled in response to the deflection detection, the information loss may occur for a range firmly pressed by the user during the operation. Each of an input device, an input processing program, and an input control method that are disclosed below has been attained to reduce the information loss and to output the contact coordinates even though a deflection occurs during the operation.

Hereinafter, the input device, the input processing program, and the input control method that relate to this application will be described with reference to the attached drawings.

Hereinafter, an exemplary input device according to a first embodiment will be described. The input device may be incorporated into a terminal device including a portable terminal, a mobile terminal, a fixed terminal, and so forth, and may be incorporated into a terminal device including, for example, a touch panel. For example, the input device according to the first embodiment measures the capacitance occurring between each of the electrodes of the touch panel and the user's finger, and outputs the contact position information to the main CPU of the terminal device based on the measured capacitances.

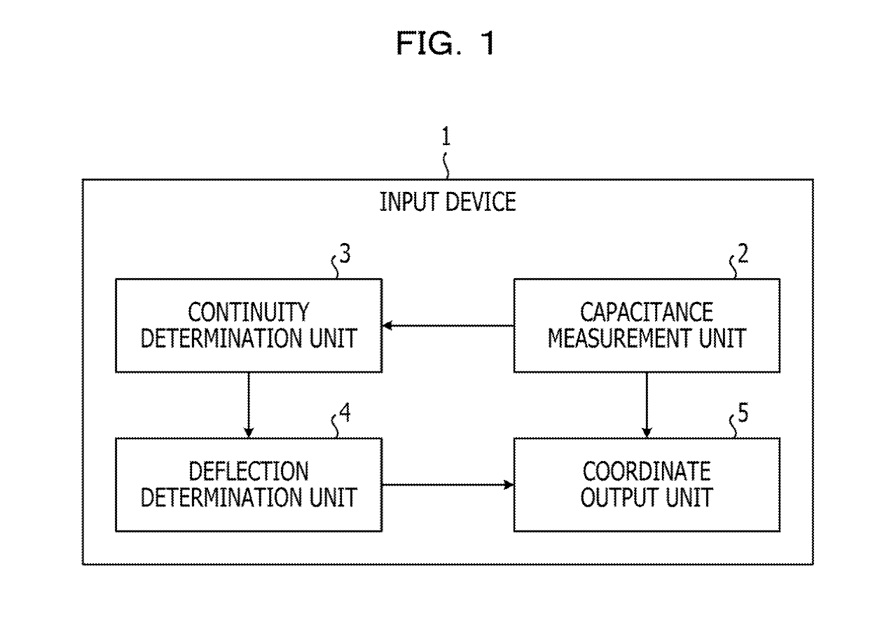

First, the exemplary input device according to the first embodiment and processing performed through the exemplary input device will be described with reference to the block diagram of FIG. 1.

The input device 1 includes a capacitance measurement unit 2, a continuity determination unit 3, a deflection determination unit 4, and a coordinate output unit 5. The capacitance measurement unit 2 measures a capacitance of each of the electrodes that are provided on the touch panel. The continuity determination unit 3 determines the presence or absence of the continuity of operation inputs for the touch panel.

When the continuity determination unit 3 determines that the continuity is absent, the deflection determination unit 4 determines the presence or absence of a deflection occurring in the touch panel based on the distribution of the measurement results of capacitances of the electrodes. The coordinate output unit 5 outputs data of the coordinates of each of the operation inputs for the touch panel based on the above-described capacitance measurement-result distribution. Then, the coordinate output unit 5 stops outputting the coordinate data when the presence of the deflection is determined by the deflection determination unit 4.

Thus, in the input device 1, when the value of a continuous touchdown count is determined to be larger than a given contact threshold value, it is determined that a user has touched the touch panel within the frame thereof firmly and continuously, and the deflection determination processing is cancelled. As a result, the input device 1 may effectively reduce the information loss which occurs in the terminal device when the user firmly presses the touch panel. The continuous touchdown count is further described later.

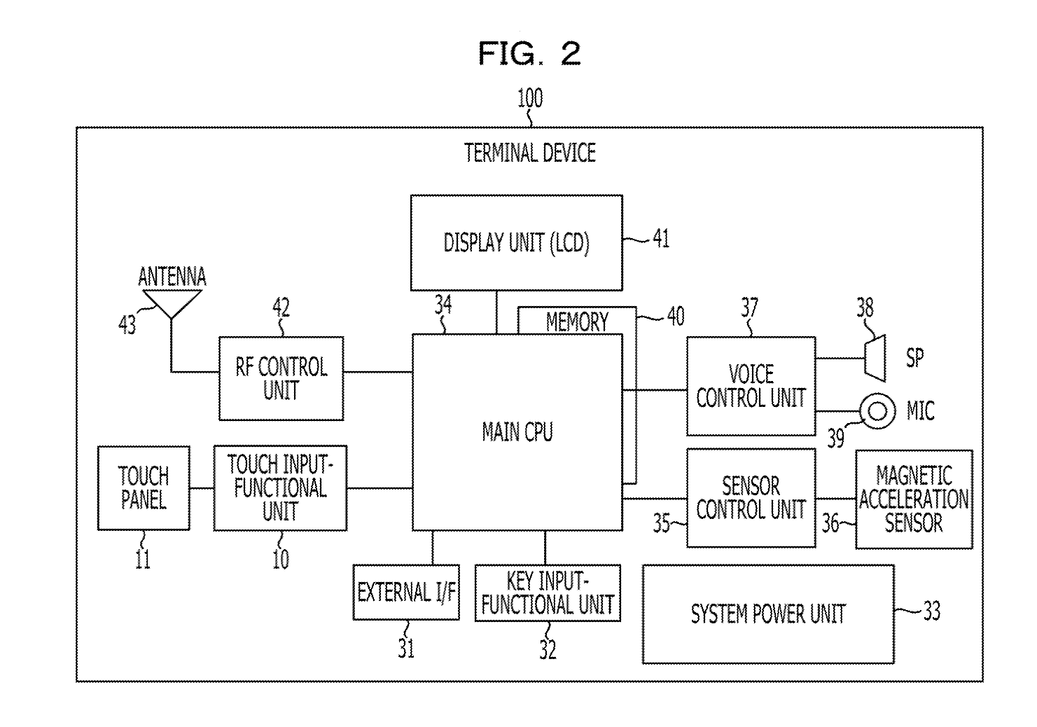

Hereinafter, an exemplary configuration of a terminal device 100 according to a second embodiment will be described with reference to FIG. 2. In the following description, the above-described terminal device 100 is used as an example for a portable phone-terminal device.

First, each of the components of the terminal device 100 will be described with reference to FIG. 2. The terminal device 100 includes a touch input-functional unit 10, a touch panel 11, an external interface (I/F) 31, a key input-functional unit 32, a system power unit 33, a main central processing unit (CPU) 34, and a sensor control unit 35, as illustrated in FIG. 2. The terminal device 100 further includes a magnetic acceleration sensor 36, a voice control unit 37, a speaker (SP) 38, a microphone (MIC) 39, a memory 40, a display unit 41, a radio frequency (RF) control unit 42, and an antenna 43.

The external I/F 31 controls communications relating to various types of information exchanged between the terminal device 100 and an external device. The key input-functional unit 32 accepts information transmitted through a key button (not shown) and notifies the main CPU 34 of the information. The system power unit 33 transmits power to each of the components.

The main CPU 34 manages the processing performed in the terminal device 100. The sensor control unit 35 controls the magnetic acceleration sensor 36. The magnetic acceleration sensor 36 measures acceleration exerted on the terminal device 100 through the use of magnetism. The voice control unit 37 controls the MIC 39 and the SP 38. The MIC 39 accepts voice information transmitted thereto and notifies the voice control unit 37 of the voice information.

The SP 38 outputs the voice information transmitted from the voice control unit 37. The memory 40 stores data and programs that are appropriate to perform various types of processing performed by the main CPU 34. The display unit 41 includes a liquid crystal display (LCD) to display image information transmitted from the main CPU 34. The RF control unit 42 converts a signal transmitted to the antenna 43 and notifies the main CPU 34 of the signal. The antenna 43 transmits and/or receives a radio wave to and/or from an external device.

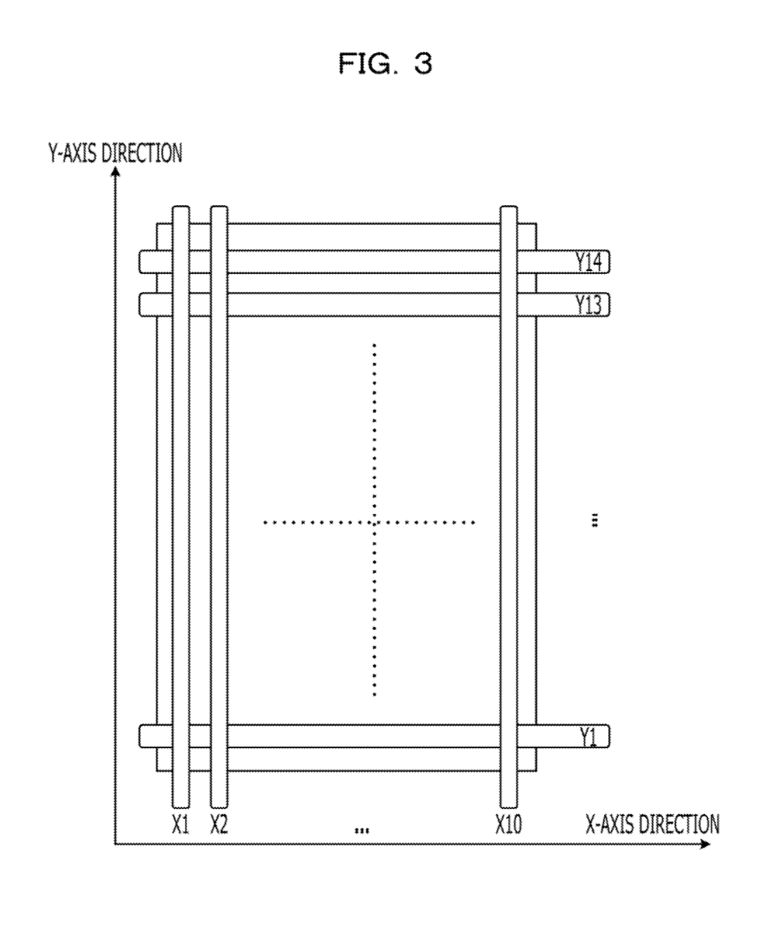

The touch panel 11 is a panel provided with a plurality of electrodes. More specifically, the touch panel 11 is provided on the face of the display unit 41, and includes a plurality of transparent electrodes arranged in a grid-form. Here, exemplary arrangement of the electrodes of the touch panel 11 will be described in detail with reference to FIG. 3. FIG. 3 illustrates the electrodes of the touch panel 11. For example, the touch panel 11 includes transparent electrodes X1 to X10 that are arranged at regular intervals in the direction of the X-axis of the display unit 41, as illustrated in FIG. 3. Further, the touch panel 11 includes transparent electrodes Y1 to Y14 that are arranged at regular intervals in the direction of the Y-axis of the display unit 41.

The touch input-functional unit 10 determines the contact position where the user's finger contacts the touch panel 11 and outputs information about the contact position to the main CPU 34. More specifically, the touch input-functional unit 10 measures the capacitance occurring between each of the electrodes of the touch panel 11 and the user's finger, and outputs the contact position information to the main CPU 34 based on the measured capacitances.

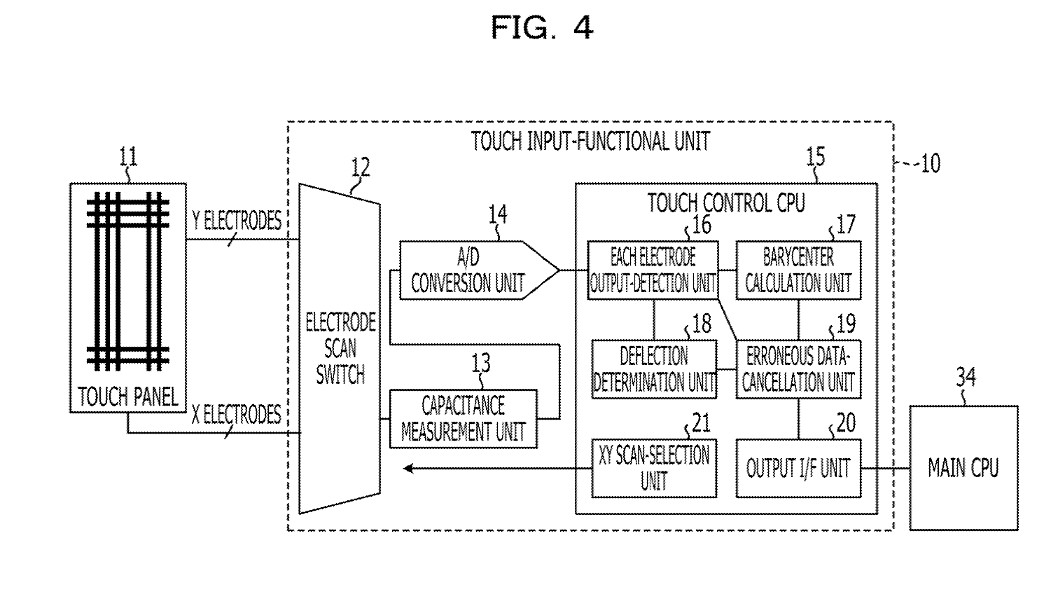

Here, the configuration of the touch input-functional unit 10 according to the second embodiment will be described in detail with reference to the block diagram of FIG. 4. The touch input-functional unit 10 includes an electrode scan switch 12, a capacitance measurement unit 13, an analog-to-digital (A/D) conversion unit 14, and a touch control CPU 15. Hereinafter, the processing of each of the above-described components will be described. Here, the touch input-functional unit 10 is connected to the touch panel 11 via the electrode scan switch 12, and is connected to the main CPU 34 via the output I/F unit 20.

The electrode scan switch 12 switches between the electrodes measuring capacitances. For example, the electrode scan switch 12 determines each of the electrodes that are arranged in the direction of an axis to be a ground, where the electrode scan switch 12 is not notified of the axis direction through an XY scan-selection unit 21. Further, the electrode scan switch 12 applies a voltage to each of the electrodes that are arranged in the direction of an axis, where the electrode scan switch 12 is notified of the axis direction through the XY scan-selection unit 21.

For example, upon being notified of the fact that the capacitance occurring in the X-axis direction is measured by the XY scan-selection unit 21, the electrode scan switch 12 determines each of the electrodes Y1 to Y14 that are arranged in the Y-axis direction to be a ground, and applies a given voltage to each of the electrodes X1 to X10 in sequence. Upon being notified of the Y-axis direction by the XY scan-selection unit 21, the electrode scan switch 12 determines each of the electrodes X1 to X10 that are arranged in the X-axis direction to be a ground, and applies a given voltage to each of the electrodes Y1 to Y14 in sequence.

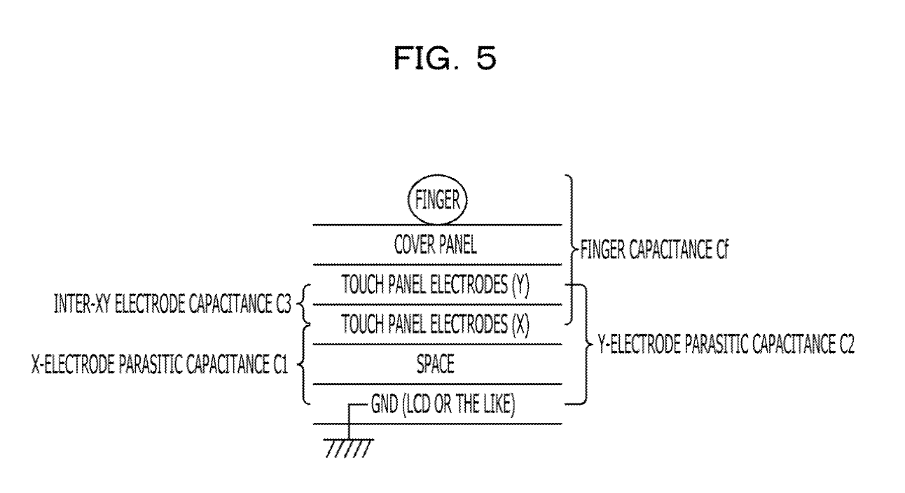

The capacitance measurement unit 13 measures the capacitance from each of the electrodes that are arranged on the touch panel 11. Here, processing performed through the capacitance measurement unit 13 to measure the capacitance from each of the electrodes will be described in detail with reference to FIG. 5. FIG. 5 illustrates a capacitance measured through the capacitance measurement unit 13.

As illustrated in FIG. 5, the terminal device 100 includes a ground (GND), electrodes that are arranged in the X-axis direction (illustrated as touch panel electrodes (X) in FIG. 5), electrodes that are arranged in the Y-axis direction (illustrated as touch panel electrodes (Y) in FIG. 5), and a cover panel, where a space is provided between the GND and the electrodes (X) that are arranged in the X-axis direction.

Then, the capacitance measurement unit 13 measures an X-electrode parasitic capacitance C1 which is a capacitance occurring between each of the electrodes that are arranged in the X-axis direction and the LCD 41 and a Y-electrode parasitic capacitance C2 which is a capacitance occurring between each of the electrodes that are arranged in the Y-axis direction and the LCD 41, as illustrated in FIG. 5. Further, the capacitance measurement unit 13 measures an inter-XY electrode capacitance C3 which is a capacitance occurring between the electrodes that are arranged in the X-axis direction and those arranged in the Y-axis direction, and a finger capacitance Cf which is a capacitance occurring between the electrodes subjected to the capacitance measurement and a finger. Further, the sign GND denotes a ground.

When measuring the capacitance from each of the electrodes that are arranged in the X-axis direction, the capacitance measurement unit 13 determines each of the electrodes that are arranged in the Y-axis direction to be a ground, measures the capacitances C1, C3, and Cf, and calculates the sum of the values of the measured capacitances (C1+C3+Cf). Further, when measuring the capacitance of each of the electrodes Y1 to Y14 that are arranged in the Y-axis direction, the capacitance measurement unit 13 determines each of the electrodes X1 to X10 that are arranged in the X-axis direction to be a ground, measures the capacitances C2, C3, and Cf, and calculates the sum of the values of the measured capacitances (C2+C3+Cf).

For example, when the user firmly presses the touch panel 11 during the operation, the capacitance measurement unit 13 measures capacitances showing a sharp peak, where the center of the sharp peak corresponds to the position where the finger contacts the touch panel 11, and measures capacitances showing a gentle peak. The A/D conversion unit 14 converts data of the capacitance value, the data being transmitted from the capacitance measurement unit 13, to digital data, and transmits the digital data to the touch control CPU 15.

As shown in FIG. 4, the touch control CPU 15 includes an each electrode-output detection unit 16 (continuity determination unit), a barycenter calculation unit 17, a deflection determination unit 18, an erroneous data-cancellation unit 19, an output I/F unit 20, and the XY scan-selection unit 21. Hereinafter, processing performed through each of the above-described units will be described.

Each electrode-output detection unit 16 determines the presence or absence of the continuity of operation inputs on the touch panel 11. For example, each electrode-output detection unit 16 has data of a continuous touchdown count indicating the number of times data, of the position where the touch panel 11 comes into contact with an object, is continuously output. Upon receiving the digitized capacitance value data transmitted from the A/D conversion unit 14, the electrode-output detection unit 16 compares the maximum value of the transmitted digitized capacitance value data with a given measurement threshold value.

When it is determined that the maximum value of the transmitted capacitance value data is smaller than the given measurement threshold value based on the comparison result, the electrode-output detection unit 16 abandons the capacitance data and changes the value of the continuous touchdown count to “0”. When it is determined that the maximum value of the transmitted capacitance value data is larger than the given measurement threshold value and the value of the continuous touchdown count is smaller than a given contact threshold value, the electrode-output detection unit 16 transmits data of the value of each of the capacitances to each of the barycenter calculation unit 17 and the deflection determination unit 18.

When it is determined that the maximum value of the transmitted capacitance value data is larger than the given measurement threshold value and the value of the continuous touchdown count is larger than the given contact threshold value, the electrode-output detection unit 16 transmits data of the value of each of the capacitances to the barycenter calculation unit 17. Upon receiving information indicating a contact coordinate output that will be described later, the information being transmitted from the erroneous data-cancellation unit 19, the each electrode-output detection unit 16 adds “1” to the value of the continuous touchdown count.

Hereinafter, processing performed through the each electrode-output detection unit 16 will be described in detail. When power is supplied to the terminal device 100, the each electrode-output detection unit 16 initializes the continuous touchdown count to “0”.

Upon receiving the digitized capacitance value data transmitted from the A/D conversion unit 14, the each electrode-output detection unit 16 compares the maximum value of the transmitted digitized capacitance value data with the given measurement threshold value. For example, upon receiving data of the value of a measured capacitance of each of the electrodes X1 to X10, the each electrode-output detection unit 16 determines whether or not the maximum value of the received capacitance value data is larger than a given measurement threshold value.

When the comparison result shows that the maximum value of the received capacitance value data is substantially equivalent to and/or less than the given measurement threshold value, the each electrode-output detection unit 16 abandons the received capacitance value data and changes the value of the continuous touchdown count to “0”. For example, when the measurement threshold value is “30” and the maximum value of the received capacitance value data is “20”, the each electrode-output detection unit 16 abandons the received capacitance value data and changes the value of the continuous touchdown count to “0”.

When the maximum value of the received capacitance value data is determined to be larger than the given measurement threshold value, the each electrode-output detection unit 16 determines whether or not the value of the continuous touchdown count is larger than the given contact threshold value. When the determination result shows that the value of the continuous touchdown count is equivalent to and/or less than the given contact threshold value, the each electrode-output detection unit 16 transmits data of the value of each of the capacitances to each of the barycenter calculation unit 17 and the deflection determination unit 18.

Further, when it is determined that the value of the continuous touchdown count is larger than the given contact threshold value, the each electrode-output detection unit 16 transmits the data of the value of each of the capacitances to the barycenter calculation unit 17. Namely, when it is determined that the value of the continuous touchdown count is larger than the given contact threshold value, the each electrode-output detection unit 16 determines that the user touches the touch panel 11 within the frame thereof firmly and continuously, and cancels the deflection determination processing. As a result, it becomes possible to reduce the data loss caused by the deflection determination processing and to output data of the coordinates of an operation input even though a deflection occurs during the operation.

Further, upon receiving information indicating that the data of contact coordinates is output, the information being transmitted from the erroneous data-cancellation unit 19 that will be described later, the each electrode-output detection unit 16 adds “1” to the value of the continuous touchdown count. For example, when the value of the continuous touchdown count is “3” and information indicating that the data of contact coordinates that will be described later is output is transmitted from the erroneous data-cancellation unit 19 to the each electrode-output detection unit 16, the each electrode-output detection unit 16 changes the value of the continuous touchdown count to “4”.

When the maximum value of capacitances that are measured through the capacitance measurement unit 13 is larger than the given measurement threshold value, the barycenter calculation unit 17 calculates the barycentric coordinates of the capacitances based on the capacitances. More specifically, upon receiving data of the value of each of the capacitances, the data being transmitted from the each electrode-output detection unit 16, the barycenter calculation unit 17 calculates barycentric coordinates relating to the capacitances based on the transmitted data, which indicates the values of the capacitances occurring in each of the axis directions. When the barycentric coordinates relating to the capacitances are calculated, the barycenter calculation unit 17 transmits information indicating the calculated barycentric coordinates relating to the capacitances to the erroneous data-cancellation unit 19.

Hereinafter, processing performed by the barycenter calculation unit 17 will be described in detail. First, upon receiving data of the value of each of the capacitances, the data being transmitted from the each electrode-output detection unit 16, the barycenter calculation unit 17 calculates the barycentric coordinates relating to the capacitances based on the transmitted data, which indicates the values of the capacitances occurring in each of the axis directions. For example, upon receiving data of the capacitance of each of the electrodes that are arranged in the X-axis direction, the data being transmitted from the each electrode-output detection unit 16, the barycenter calculation unit 17 calculates the barycenter of the distribution of the capacitances of the electrodes that are arranged in the X-axis direction, as the coordinates of the contact position.

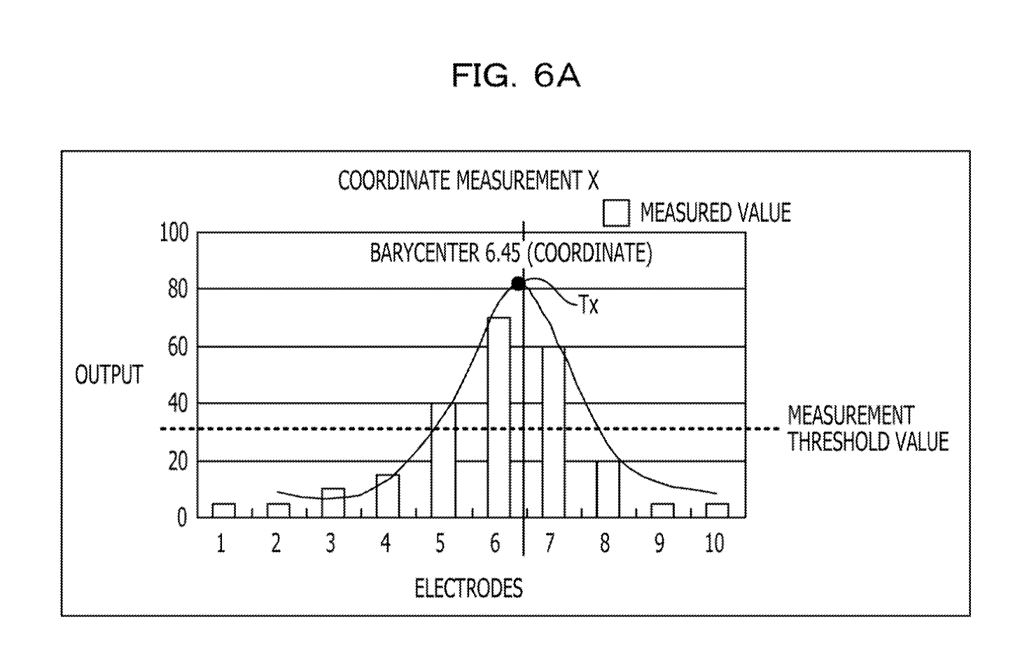

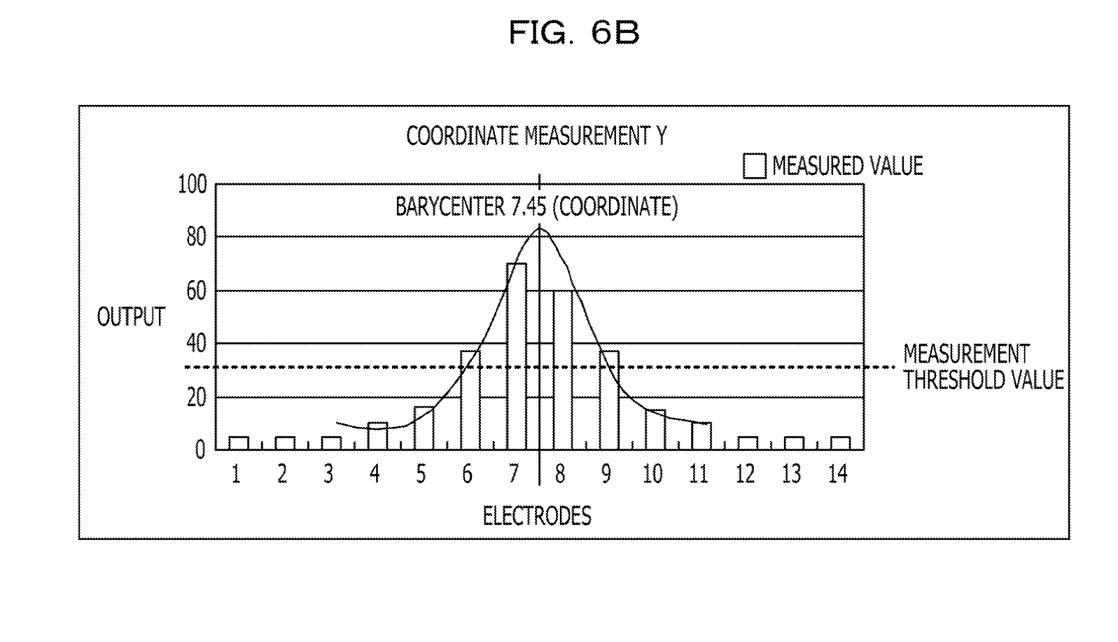

Here, processing performed to calculate the barycentric coordinates of capacitances occurring in each of the X-axis direction and the Y-axis direction will be described with reference to FIGS. 6A and 6B. Each of FIGS. 6A and 6B illustrates how the barycentric coordinates of the capacitances are calculated. FIG. 6A illustrates an exemplary graphic plot of the positions of the electrodes X1 to X10 that are arranged in the X-axis direction, where the positions are illustrated along the horizontal axis direction, and the values of the capacitances of the electrodes X1 to X10, where the capacitance values are illustrated along the vertical axis direction. Further, FIG. 6B illustrates an exemplary graphic plot of the positions of the electrodes Y1 to Y14 that are arranged in the Y-axis direction, where the positions are illustrated along the horizontal axis direction, and the values of the capacitances of the electrodes Y1 to Y14, where the capacitance values are illustrated along the vertical axis direction.

For example, when calculating the barycentric coordinates of the capacitances occurring along the X-axis direction, the barycenter calculation unit 17 calculates a normal distribution function approximating the values of the capacitances. Then, the barycenter calculation unit 17 calculates the horizontal coordinate of the point corresponding to the maximum value of the capacitances that are illustrated by the calculated normal distribution function, and determines the calculated coordinate to be the barycentric coordinates of the capacitances occurring along the X-axis direction. According to the graphic plot illustrated in FIG. 6A, the barycenter calculation unit 17 calculates the horizontal coordinate “6.45” of the point “Tx” where the calculated normal distribution function is maximized, as the barycentric coordinates of the capacitances occurring in the X-axis direction. Likewise, according to the graphic plot illustrated in FIG. 6B, the barycenter calculation unit 17 calculates the barycentric coordinates “7.45” of the capacitances occurring in the Y-axis direction.

When it is determined that the continuity is absent, the deflection determination unit 18 determines the presence or absence of a deflection occurring in the touch panel 11 based on the distribution of the results of the measurement of capacitances of the electrodes. For example, upon receiving data of the values of a plurality of capacitances, the deflection determination unit 18 compares the deflection threshold value lower than the measurement threshold value with the values of the transmitted capacitance data, and determines the number of capacitances with values larger than the deflection threshold value.

If the determination result shows that the number of the capacitances having values larger than the deflection threshold value is larger than a given number, the deflection determination unit 18 determines that a deflection has occurred in the touch panel 11, and transmits information indicating that the deflection occurs in the touch panel 11 to the erroneous data-cancellation unit 19. Further, when the each electrode-output detection unit 16 determines that the touch panel 11 comes into contact with an object continuously, the deflection determination unit 18 abandons the capacitance value data without transmitting the capacitance value data to the erroneous data-cancellation unit 19.

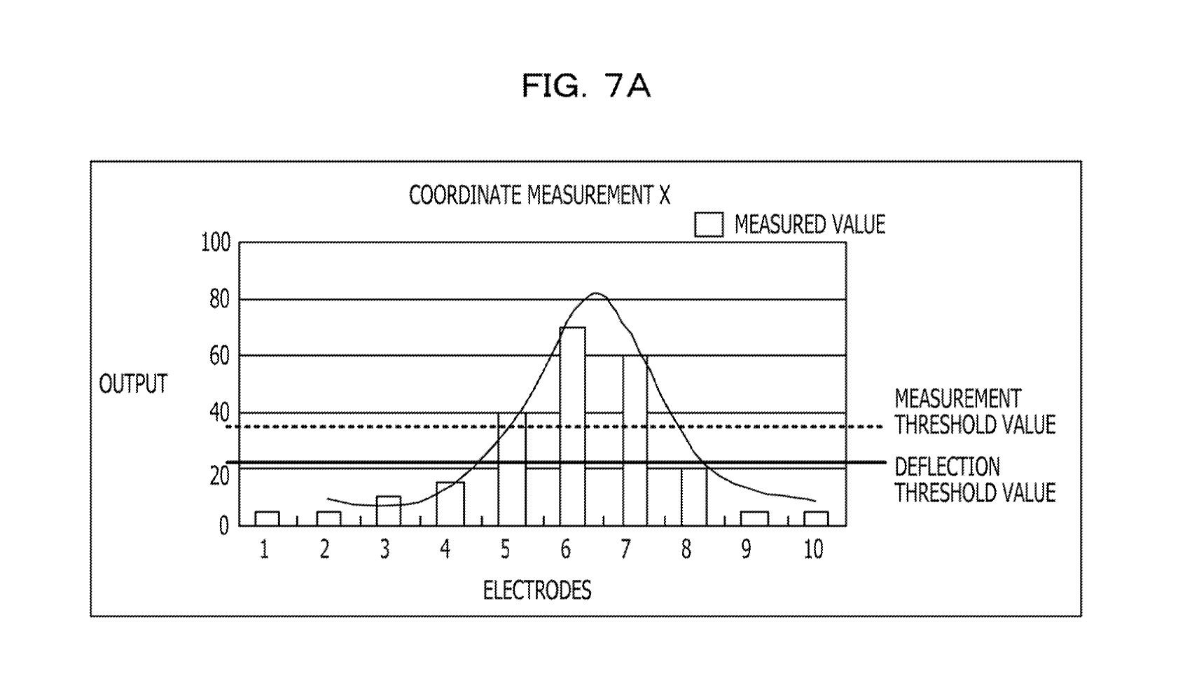

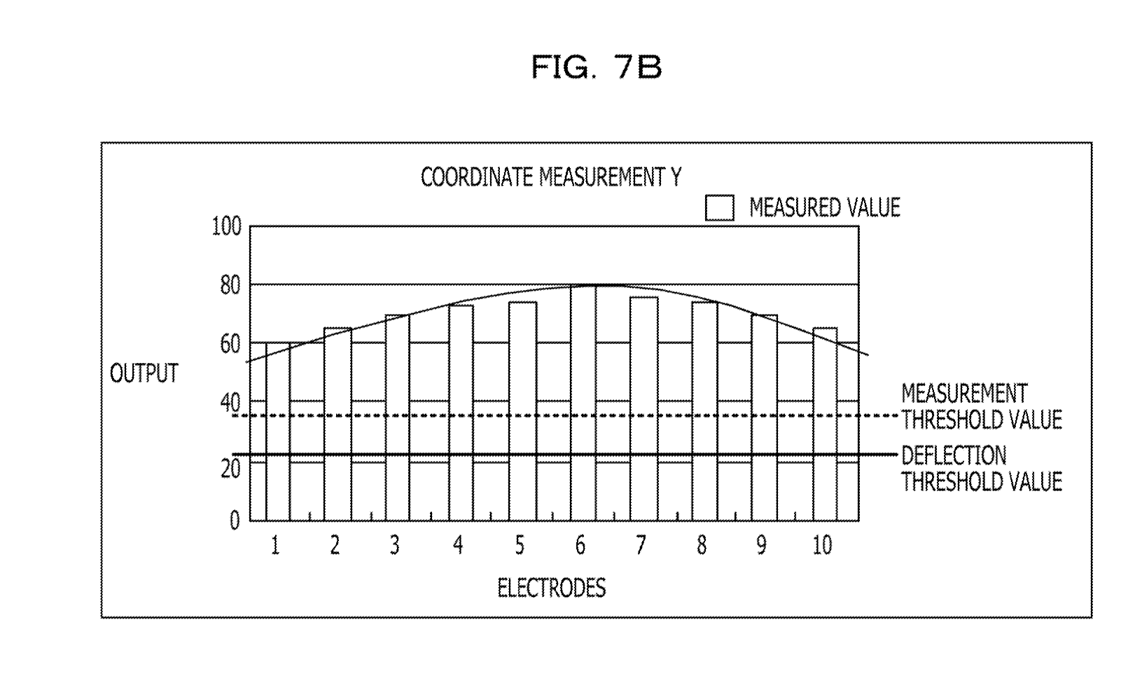

Here, processing performed by the deflection determination unit 18 to compare the value of the transmitted capacitance data with the deflection threshold value will be described in detail with reference to FIGS. 7A and 7B. Each of FIGS. 7A and 7B illustrates the deflection determination. According to an example illustrated in each of FIGS. 7A and 7B, the deflection determination unit 18 stores data “25” as the deflection threshold value and data “35” as the measurement threshold value.

When the finger of the user comes into contact with the touch panel 11, the capacitance Cf increases with a decrease in the distance between the electrode and the finger as illustrated in FIG. 7A so that the terminal device 100 measures capacitances showing a sharp peak. Further, when the finger of the user presses the touch panel 11 firmly and continuously so that a deflection occurs in the touch panel 11, the parasitic capacitances C1 and C2 of each of the electrodes are increased so that the capacitance of each of the electrodes is increased as illustrated in FIG. 7B. Consequently, the terminal device 100 measures capacitances showing a gentle peak.

According to the example illustrated in FIG. 7A, the deflection determination unit 18 compares the deflection threshold value with the value of each of the capacitances of which data is transmitted to the deflection determination unit 18, and determines that three capacitances with values larger than the deflection threshold value are measured. Further, according to the example illustrated in FIG. 7B, the deflection determination unit 18 compares the deflection threshold value with the value of each of the capacitances of which data is transmitted to the deflection determination unit 18, and determines that ten capacitances with values larger than the deflection threshold value are measured. After that, when it is determined that the number of capacitances having values larger than the deflection threshold value is larger than the given number, the deflection determination unit 18 determines that a deflection occurs in the touch panel 11, and transmits information indicating that a deflection has occurred in the touch panel 11 to the erroneous data-cancellation unit 19.

The erroneous data-cancellation unit 19 outputs data of the coordinates of an operation input for the touch panel 11 based on the distribution of the results of measurement of the capacitances of a plurality of electrodes. Further, the erroneous data-cancellation unit 19 stops outputting the coordinate data when the presence of a deflection is determined.

For example, when the deflection determination unit 18 determines that a deflection occurs in the touch panel 11, the erroneous data-cancellation unit 19 does not output data of the barycentric coordinates that are calculated through the barycenter calculation unit 17. When the deflection determination unit 18 determines that no deflection occurs in the touch panel 11, the erroneous data-cancellation unit 19 outputs data of the barycentric coordinates that are calculated by the barycenter calculation unit 17. When the each electrode-output detection unit 16 determines that the touch panel 11 comes into contact with an object continuously, the erroneous data-cancellation unit 19 outputs data of the barycentric coordinates that are calculated by the barycenter calculation unit 17.

For example, the erroneous data-cancellation unit 19 receives information indicating the barycentric coordinates corresponding to each of the X-axis direction and the Y-axis direction, the information being transmitted from the barycenter calculation unit 17. Then, upon receiving information transmitted from the deflection determination unit 18, the information indicating that a deflection occurs in the touch panel 11, within a given time of the reception of the information indicating the barycentric coordinates corresponding to each of the X-axis direction and the Y-axis direction, the erroneous data-cancellation unit 19 abandons the received information indicating the barycentric coordinates corresponding to each of the axis directions without transmitting the above-described received information.

On the other hand, when the erroneous data-cancellation unit 19 does not receive the information indicating that a deflection has occurred in the touch panel 11 within the given time of the reception of the information indicating the barycentric coordinates corresponding to each of the axis directions, the erroneous data-cancellation unit 19 transmits the received information indicating the barycentric coordinates corresponding to each of the axis directions to the output I/F unit 20, as data of the coordinates of the contact position. Then, when the received information indicating the barycentric coordinates corresponding to each of the axis directions is transmitted to the output I/F unit 20, as the data of the coordinates of the contact position, the erroneous data-cancellation unit 19 transmits information indicating that the contact coordinate data is output to the each electrode-output detection unit 16.

Further, when the erroneous data-cancellation unit 19 does not receive the information indicating that a deflection has occurred in the touch panel 11 within the given time of the reception of the information indicating the barycentric coordinates corresponding to each of the axis directions, the erroneous data-cancellation unit 19 transmits the received information indicating the barycentric coordinates corresponding to each of the axis directions to the output I/F unit 20, as the data of the coordinates of the contact position.

For example, upon receiving the information indicating that a deflection has occurred in the touch panel 11 before the expiration of “1 ms” after the reception of the information indicating the barycentric coordinates, the erroneous data-cancellation unit 19 abandons the received barycentric coordinate information without transmitting the above-described received information. Further, when the erroneous data-cancellation unit 19 does not receive the information indicating that a deflection occurs in the touch panel 11 before the expiration of “1 ms” after the reception of the information indicating the barycentric coordinates, the erroneous data-cancellation unit 19 transmits the received information indicating the barycentric coordinates to the output I/F unit 29, as the data of the coordinates of the contact position.

Namely, when the each electrode-output detection unit 16 determines that the touch panel 11 comes into contact with an object continuously, the erroneous data-cancellation unit 19 does not receive the information indicating that a deflection occurs in the touch panel 11. Therefore, when the user touches the touch panel 11 within the frame thereof firmly and continuously, the erroneous data-cancellation unit 19 outputs the information about the barycentric coordinates that are calculated through the barycenter calculation unit 17.

The output I/F unit 20 outputs data indicating the contact coordinates, the data being transmitted from the erroneous data-cancellation unit 19, to the main CPU 34. The XY scan-selection unit 21 selects either measuring the capacitances occurring in the X-axis direction or measuring the capacitances occurring in the Y-axis direction, and notifies the electrode scan switch 12 of an instruction to measure the capacitances occurring in the selected axis direction.

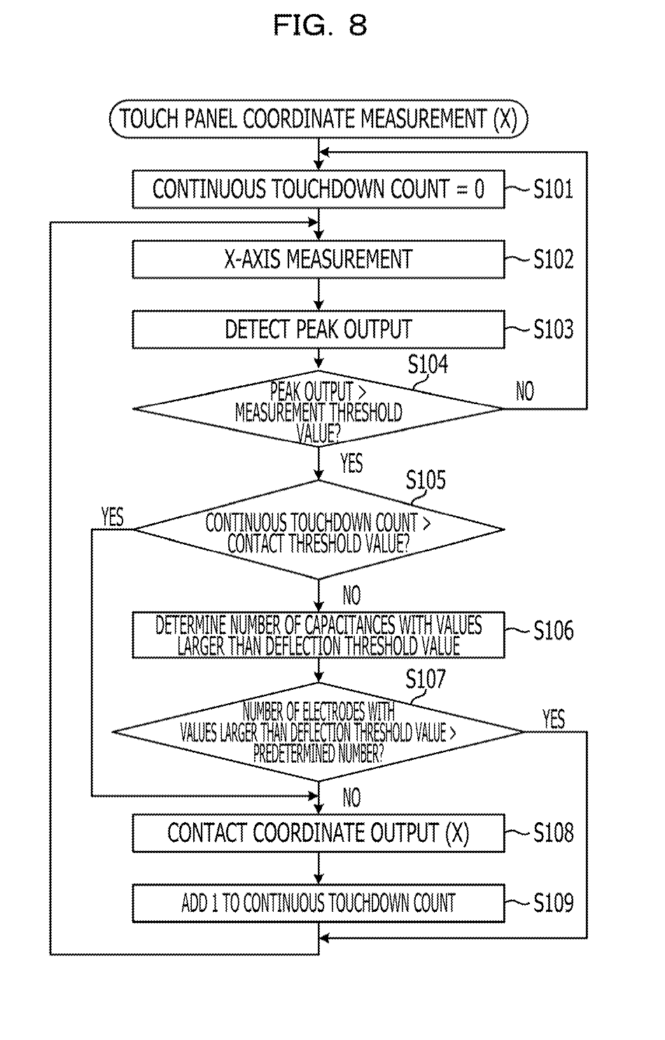

Thus, when it is determined that the touch panel 11 comes into contact with an object continuously, the terminal device 100 cancels the deflection determination processing performed through the deflection determination unit 18 and outputs data of the barycentric coordinates, so that the contact coordinate data is output even though a deflection occurs during the operation.

[Processing of Terminal device] Next, exemplary flow of processing procedures that are performed through the terminal device 100 according to the second embodiment will be described with reference to the flowchart of FIG. 8. Although the processing procedures that are performed to measure the touch panel coordinate (X) are illustrated in FIG. 8, the same processing procedures may be performed to measure the touch panel coordinate (Y). Further, in the following descriptions, capacitances that are measured for the electrodes X1 to X10 that are arranged in the X-axis direction are determined to be capacitances CX1 to CX10, and those measured for the electrodes Y1 to Y14 that are arranged in the Y-axis direction are determined to be capacitances CY1 to CY14.

As illustrated in FIG. 8, the terminal device 100 initializes the continuous touchdown count to “0” at step S101. Then, the terminal device 100 measures the capacitances CX1 to CX10 of the electrodes X1 to X10 that are arranged in the X-axis direction at step S102. Next, the terminal device 100 detects the capacitance with the peak value of the measured capacitances CX1 to CX10 at step S103. Then, the terminal device 100 determines whether or not the peak value of the capacitance is larger than the measurement threshold value at step S104.

If the determination result shows that the peak value of the capacitances CX1 to CX10 is larger than the measurement threshold value, which means that the answer is yes at step S104, the terminal device 100 determines whether or not the value of the continuous touchdown count is larger than the contact threshold value at step S105. When the value of the continuous touchdown count is larger than the contact threshold value, which means that the answer is yes at step S105, the terminal device 100 outputs data of the X-axis contact coordinate at step S108. Further, the terminal device 100 adds the value 1 to the value of the continuous touchdown count at step S109.

On the other hand, when the peak value of the capacitances CX1 to CX10 is not larger than the measurement threshold value, which means that the answer is no at step S104, the terminal device 100 initializes the value of the continuous touchdown count to “0” at step S101, and performs the processing procedures again at steps S101 to S104. Further, when the value of the continuous touchdown count is equivalent to and/or less than the contact threshold value, which means that the answer is no at step S105, the terminal device 100 determines the number of capacitances with values larger than the deflection threshold value at step S106.

Next, the terminal device 100 determines whether or not the number of the capacitances with values larger than the deflection threshold value is larger than a given number at step S107. When the number of the capacitances with values larger than the deflection threshold value is larger than the given number, which means that the answer is yes at step S107, the terminal device 100 measures the capacitance of each of the electrodes again without outputting data of the contact coordinates at step S102. On the other hand, when the number of the capacitances with values larger than the deflection threshold value is smaller than the given number, which means that the answer is no at step S107, the terminal device 100 outputs the contact coordinate data at step S108.

As described above, the terminal device 100 according to the second embodiment measures the capacitances of the plurality of electrodes arranged on the touch panel 11 and determines the presence or absence of the continuity of operation outputs for the touch panel 11. When it is determined that the continuity is absent, the terminal device 100 determines the presence or absence of a deflection occurring in the touch panel 11 based on the distribution of the results of measurement of the capacitances of the electrodes, and stops outputting the coordinate data when it is determined that the deflection is present. Consequently, the terminal device 100 determines that the user touches the touch panel 11 within the frame thereof firmly and continuously, and cancels the deflection determination processing. As a result, the terminal device 100 reduces the information loss occurring in an area defined on the touch panel, where the user firmly presses the touch panel within the area during the operation.

Further, the terminal device 100 compares the values of a plurality of capacitance outputs that are measured from the plurality of electrodes with the deflection threshold value, and determines that a deflection occurs when the number of capacitance outputs with values larger than the deflection threshold value is larger than a given number. Consequently, the terminal device 100 determines a deflection.

Further, when any of the plurality of capacitance outputs has a value larger than the measurement threshold value larger than the deflection threshold value, the terminal device 100 outputs data of the barycenter of the distribution of the capacitance outputs as the coordinate data. Therefore, it becomes possible to appropriately output data of the coordinates of the position where the user touches the touch panel.

Further, the terminal device 100 measures the capacitances of the electrodes repeatedly. When a capacitance output with a value larger than the measurement threshold value is continuously obtained over at least a given number of times as a result of the measurement, the terminal device 100 determines that the continuity is present. Therefore, the terminal device 100 determines that the user touches the touch panel firmly and continuously within the frame of the touch panel.

Further, the touch panel 11 is placed over a display device so as to be away from the display device by as much as a given distance. Namely, space is provided between the touch panel and the display device so that the terminal device 100 detects the user coming into contact with the touch panel 11.

Hereinafter, exemplary modifications of the above-described embodiments will be described.

(1) Deflection Determination in the above-described second embodiment, the actual execution of the deflection determination processing is cancelled when it is determined that the continuity of the operation inputs is present. According to a third embodiment, however, the result of the deflection determination may be cancelled without being limited to the second embodiment.

More specifically, the terminal device measures capacitances from the plurality of electrodes arranged on the touch panel, determines the presence or absence of the continuity of operation inputs for the touch panel, and determines the presence or absence of a deflection occurring in the touch panel based on the distribution of the results of the measurement of capacitances of the electrodes. If the determination results indicate that the continuity is absent and the deflection occurs, the terminal device stops outputting the coordinate data.

Thus, the terminal device 100 according to the third embodiment measures the capacitances from the electrodes that are arranged on the touch panel, determines the presence or absence of the continuity of the operation inputs for the touch panel, and determines the presence or absence of a deflection occurring in the touch panel based on the distribution of the results of the measurement of capacitances of the electrodes. Then, if it is determined that the continuity is absent and the deflection occurs, the terminal device 100 stops outputting the coordinate data. As a result, the terminal device 100 determines that the user touches the touch panel 11 within the frame thereof firmly and continuously, and cancels the deflection determination processing. As a result, the terminal device 100 reduces the information loss occurring in an area defined on the touch panel, where the user firmly presses the touch panel within the area during the operation.

(2) Electrodes The terminal device 100 according to the above-described second embodiment includes ten electrodes that are arranged in the X-axis direction and fourteen electrodes that are arranged in the Y-axis direction. In the third embodiment, however, an arbitrary number of electrodes may be arranged in each of the axis directions without being limited to the second embodiment. Namely, any number of electrodes will do so long as the coordinates of the finger contact with the touch panel 11 can be identified.

(3) Processing of each of Components The components of each of the devices are functionally and conceptually illustrated in the attached drawings, and may not be configured as physically as illustrated in the drawings. Namely, the specific form of distribution and/or integration of the devices is not limited to those illustrated in the drawings, and all or part of the devices may be distributed and/or integrated functionally and/or physically in an arbitrary unit based on various loads and/or service conditions. For example, the each electrode output-detection unit 16 may be integrated into the barycenter calculation unit 17.

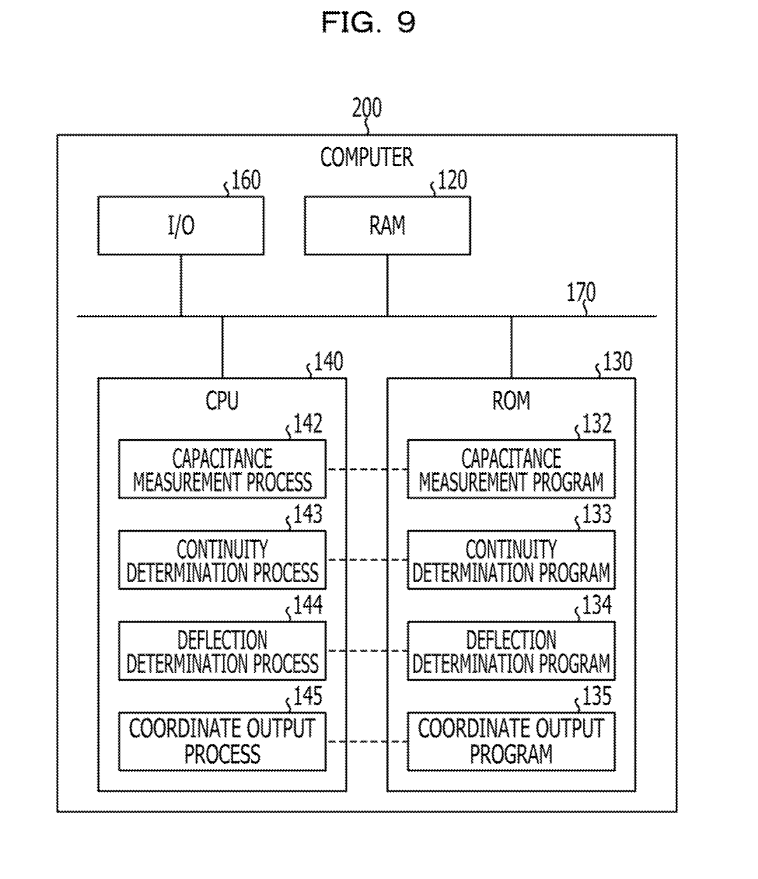

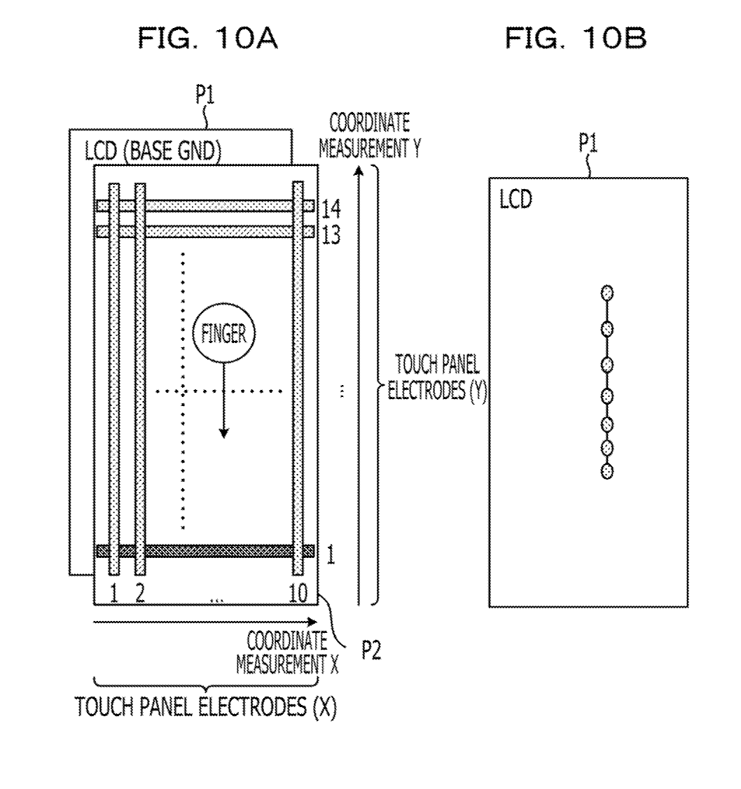

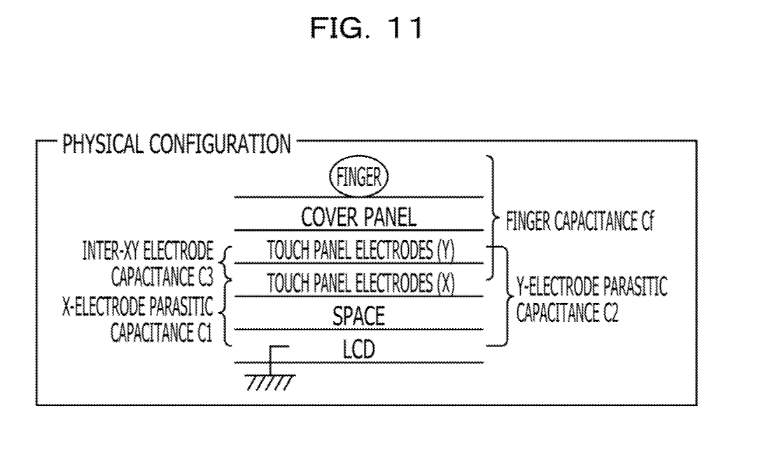

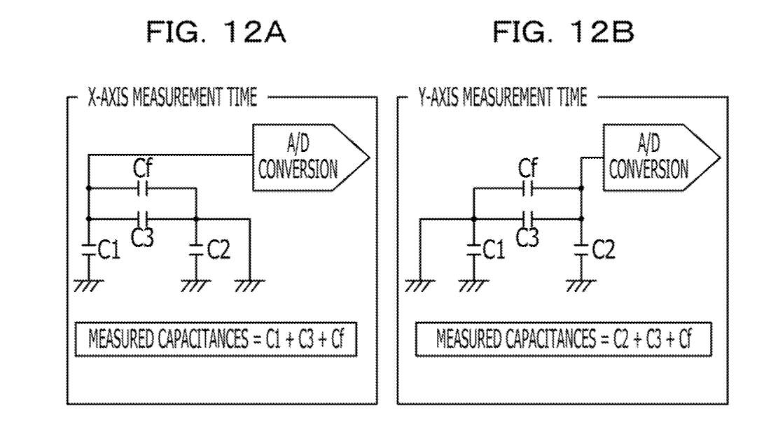

(4) Program Incidentally, the terminal device according to the second embodiment attains the various types of processing through the use of hardware. In the third embodiment, however, the various types of processing may be attained through a computer executing a program prepared in advance, the computer being provided in the terminal device, without being limited to the above-described configuration. Hereinafter, therefore, an exemplary computer 200 executing a control program having the same functions as those of the input device illustrated in the first embodiment will be described with reference to FIG. 9.

In the exemplary computer 200 illustrated in FIG. 9, a random access memory (RAM) 120, a read only memory (ROM) 130, and a central processing unit (CPU) 140 are connected to one another via a bus 170. Further, a connection terminal part I/O 160 provided to connect to an RF unit provided as radio resources, and/or an antenna are connected to the bus 170.

A capacitance measurement program 132, a continuity determination program 133, a deflection determination program 134, and a coordinate output program 135 are stored in the ROM 130 in advance. According to the example illustrated in FIG. 9, the CPU 140 executes the programs 132 and 133 that are read from the ROM 130 so that the programs 132 and 133 function as the respective capacitance measurement process 142 and continuity determination process 143. Further, the CPU 140 executes the programs 134 and 135 that are read from the ROM 130 so that the programs 134 and 135 function as the respective deflection determination process 144 and coordinate output process 145. Incidentally, the processes 142 to 145 may have the same functions as those of the units 2 to 5 that are illustrated in FIG. 1. Further, the processes 142 to 145 may have the same functions as those of the unit 13 and the units 16 to 19 according to the second embodiment.

The control program illustrated in the third embodiment may be attained through a computer executing a program prepared in advance, where the computer includes a personal computer, a workstation, and so forth. The program may be distributed via a network including the Internet or the like. Further, the program is stored in a computer-readable recording medium including a hard disk, a flexible disk (FD), a compact disk-read only memory (CD-ROM), a magneto-optical disk (MO), a digital versatile disk (DVD), etc. Still further, the program may be executed through a computer reading the program from the recording medium.

What is claimed is:

1. An input device comprising:
a capacitance measurement unit configured to measure capacitances from a plurality of electrodes arranged on a touch panel;
a deflection determination unit configured to determine a presence or absence of a deflection occurring in the touch panel based on a distribution of results of the capacitances; and
a coordinate output unit configured to output coordinate data of an operation input on the touch panel based on the distribution of results when it is determined that the deflection is absent.

2. The input device according to claim 1, further comprising a continuity determination unit configured to determine a presence or absence of continuity of the operation input on the touch panel.

3. The input device according to claim 2,
wherein the capacitance measurement unit repeatedly measures the capacitances of the plurality of electrodes and the continuity determination unit determines that the continuity is present when at least one capacitance output value is larger than a measurement threshold value a predetermined number times.

4. The input device according to claim 2, wherein the deflection determination unit determines the presence or absence of the deflection when the continuity determination unit determines that the continuity is absent.

5. The input device according to claim 1, further comprising a continuity determination unit configured to determine a presence or absence of continuity of the operation input on the touch panel.

6. The input device according to claim 5, wherein the coordinate output unit stops outputting the coordinate data when the continuity determination determines that the continuity is absent and the deflection determination unit determines that the deflection is present.

7. The input device according to claim 1,
wherein the deflection determination unit compares a plurality of capacitance outputs measured from the electrodes with a deflection threshold value and determines that the deflection is present when a number of the plurality of capacitance outputs with value larger than the deflection threshold value is equivalent to and/or larger than a given number.

8. The input device according to claim 7,
wherein when any of the capacitance outputs exceeds a measurement threshold value larger than the deflection threshold value, the coordinate output unit outputs data of a barycenter of distribution of the capacitance outputs as the coordinate data.

9. The input device according to claim 1,
wherein the touch panel is provided over a display device and separated from the display device by a predetermined distance.

10. The input device according to claim 1,
wherein the coordinate output unit stops outputting the coordinate data when the deflection determination unit determines that the deflection is present.

11. A computer readable storage medium having program code stored in a memory that, when executed by a processor, controls an input, the computer readable storage medium comprising:
program code to measure capacitances of a plurality of electrodes arranged on a touch panel;
program code to determine a presence or absence of a deflection occurring in the touch panel based on a distribution of results of the capacitances; and
program code to output coordinate data of an operation input on the touch panel based on the distribution of results when it is determined that the deflection is absent.

12. The computer readable storage medium according to claim 11, further comprising program code for determining a presence or absence of continuity of operation inputs for the touch panel.

13. The computer readable storage medium according to claim 11, further comprising program code to stop outputting the coordinate data when the program code to determine a presence or absence of a deflection determines that the deflection is present.

14. An input control method comprising:
measuring capacitances of a plurality of electrodes arranged on a touch panel;
determining a presence or absence of a deflection occurring in the touch panel based on a distribution of results of the capacitances; and
outputting coordinate data of the operation input on the touch panel based on the distribution of results when it is determined that the deflection is absent.

15. The input control method according to claim 14, further comprising determining a presence or absence of continuity of an operation input on the touch panel.

16. The input control method according to claim 14, further comprising stopping output of the coordinate data when a determination is made that the deflection is present.
